(19) United States
(12) Patent Application Publication
(10) Pub. No.: US 2018/0229493 A1
(43) Pub. Date: Aug. 16, 2018

(54) TABLET PRINTING APPARATUS

(71) Applicant: SHIBAURA MECHATRONICS CORPORATION, Yokohama-shi (JP)

(72) Inventors: Azusa HIRANO, Yokohama-shi (JP); Yasutsugu Tsuruoka, Yokohama-shi (JP); Yuki Umemura, Yokohama-shi (JP); Junsuke Komito, Yokohama-shi (JP)

(73) Assignee: SHIBAURA MECHATRONICS CORPORATION, Yokohama-shi (JP)

(21) Appl. No.: 15/897,513

(22) Filed: Feb. 15, 2018

(30) Foreign Application Priority Data
Feb. 16, 2017 (JP) 2017-026949
Jan. 24, 2018 (JP) 2018-009625

(51) Int. Cl. B41F 17/36; B41J 2/145; B41J 13/08; B41M 5/00; B41J 13/00; B41J 2/165; A61J 3/00

(52) U.S. Cl. CPC B41F 17/36; B41J 2/145; B41J 13/08; A61J 2205/50; B41J 13/0009; B41J 2/165; A61J 3/007; B41M 5/0088

(57) ABSTRACT

According to one embodiment, a tablet printing apparatus includes: a conveyor belt that includes a suction hole connected to a suction chamber, and conveys a tablet while sucking the tablet to the suction hole; an ink jet print head that has a nozzle surface where a nozzle is formed, and is located above the conveyor belt such that the nozzle surface faces the conveyor belt, and performs printing on the tablet conveyed by the conveyor belt; and a control plate that is located on the upstream side of the print head in the conveying direction of the tablet between the conveyor belt and the height position of the nozzle surface of the print head, and controls an airflow generated between the conveyor belt and the print head.

### CROSS-REFERENCE TO THE RELATED APPLICATION

This application is based upon and claims the benefit of priority from Japanese Patent Applications No. 2017-026949, filed on Feb. 16, 2017 and No. 2018-009625, filed on Jan. 24, 2018; the entire contents of all of which are incorporated herein by reference.

### FIELD

Embodiments described herein relate generally to a tablet printing apparatus.

### BACKGROUND

A technique that uses an inkjet print head to preform printing is known for printing identification information such as characters, letters, marks or the like on a tablet. In the tablet printing apparatus using this technique, tablets are conveyed by a tablet conveying device such as a conveyor. Ink (for example, edible ink) is ejected from a nozzle of the inkjet print head located above the tablet conveying device toward each tablet passing under the print head to print identification information on the tablet. As a tablet conveying device, a device that sucks and holds tablets on a conveyor belt has been developed. A plurality of suction holes of, for example, circular or rectangular shape are arranged so as to line up in the conveying direction of the tablets in the conveyor belt of the suction type tablet conveying device to suck and hold the tablets.

In the conveyor belt of the suction type tablet conveying device, tablets supplied onto the suction holes are held on the conveyor belt by suction from the suction holes. However, there are cases where the suction hole is not completely closed by the tablet. That is, a portion of the suction hole may not be closed depending on the size, shape, posture, or the like of the tablet. Besides, the suction hole may not be closed at all due to random supply of the tablet. When the suction hole is not completely closed by the tablet, an airflow is generated above the suction hole as the air is sucked from the suction hole. When the tablet is being conveyed, the surface of the conveyor belt moves along the conveying direction of the tablet. As a result, an airflow flowing along the conveying direction of the tablet also occurs on the conveyor belt due to the movement of the conveyor belt. Such various airflows are mixed and generate turbulence. Further, when the print head and its surrounding members are located above the conveyor belt, the airflow flowing above the conveyor belt strikes these members, which generates further turbulence.

When an airflow such as the turbulence occurs below the print head or in the vicinity thereof, powder of the tablet adhering to the conveyor belt or the tablet may fly and adhere to the nozzle surface (the surface on which the nozzle is formed) of the print head. If the tablet powder adheres to the nozzle surface, the nozzle may be clogged, resulting in ejection failure, or the ink ejected from the nozzle may not fly normally and land at a position other than a desired position on the tablet, resulting in reduced print quality.

In addition, if an airflow such as the turbulence occurs below the print head or in the vicinity thereof, when the tablet passes under the print head, the tablet sucked and held by the conveyor belt shake due to the turbulence and the posture of the print surface of the tablet cannot be maintained. If the posture of the print surface of the tablet cannot be maintained, the ink may land at a position other than a desired position on the tablet, resulting in reduced print quality.

### BRIEF DESCRIPTION OF THE DRAWINGS

FIG. 1 is a diagram illustrating the schematic configuration of a tablet printing apparatus according to a first embodiment;

FIG. 2 is a plan view illustrating a part of a first printing device of the first embodiment;

FIG. 3 is a diagram illustrating a part of the first printing device of the first embodiment;

FIG. 4 is a cross-sectional view taken along the line 4-4 in FIG. 3;

FIG. 5 is a diagram illustrating a result of comparison between the tablet printing apparatus of the first embodiment and another tablet printing apparatus;

FIG. 6 is a diagram illustrating a part of a first printing device according to a second embodiment;

FIG. 7 is a diagram illustrating a part of a first printing device according to a third embodiment;

FIG. 8 is a cross-sectional view taken along the line 8-8 in FIG. 7;

FIG. 9 is a diagram illustrating a control plate according to a fourth embodiment;

FIG. 10 is a diagram illustrating a control plate according to a fifth embodiment;

FIG. 11 is a diagram illustrating a modification of the control plate of the fifth embodiment;

FIG. 12 is a diagram illustrating a control plate according to a sixth embodiment; and

FIG. 13 is a diagram illustrating a control plate according to a seventh embodiment.

### DETAILED DESCRIPTION

According to one embodiment, a tablet printing apparatus includes: a conveyor belt that includes a suction hole connected to a suction chamber, and conveys a tablet while sucking the tablet to the suction hole; an ink jet print head that has a nozzle surface where a nozzle is formed, and is located above the conveyor belt such that the nozzle surface faces the conveyor belt, and performs printing on the tablet conveyed by the conveyor belt; and a control plate that is located on the upstream side of the print head in the conveying direction of the tablet between the conveyor belt and the height position of the nozzle surface of the print head, and controls an airflow generated between the conveyor belt and the print head.

### First Embodiment

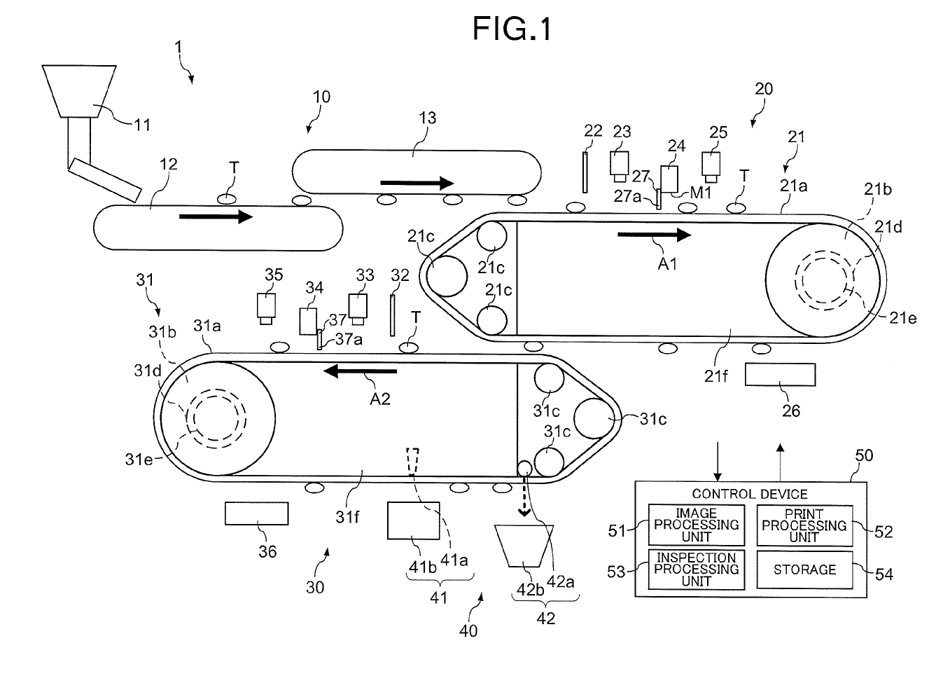

A first embodiment will be described with reference to FIGS. 1 to 5.

### (Basic Configuration)

As illustrated in FIG. 1, a tablet printing apparatus 1 of the first embodiment includes a supply device 10, a first printing device 20, a second printing device 30, a collecting device 40, and a control device 50. The first printing device 20 and the second printing device 30 basically have the same structure.

The supply device 10 includes a hopper 11, an alignment feeder 12, and a transfer feeder 13. The supply device 10 is configured to be capable of supplying tablets T to be printed to the first printing device 20, and is located on one end side of the first printing device 20. The hopper 11 stores a number of tablets T and sequentially supplies the tablets T to the alignment feeder 12. The alignment feeder 12 aligns the supplied tablets T in two rows and conveys them to the transfer feeder 13. The transfer feeder 13 sequentially sucks the tablets T on the alignment feeder 12 and conveys them in two rows to the first printing device 20. The transfer feeder 13 supplies the first printing device 20 with the tablets T in two rows. The supply device 10 is electrically connected to the control device 50, and is driven under the control of the control device 50. As the alignment feeder 12 and the transfer feeder 13, for example, a belt conveying mechanism can be used. Incidentally, the tablet T to be printed is in a three-dimensional shape and has a thickness.

The first printing device 20 includes a conveying device (tablet conveying device) 21, a detecting device 22, a first imaging device (imaging device for printing) 23, a print head device 24, a second imaging device (imaging device for inspection) 25, and a drying device 26.

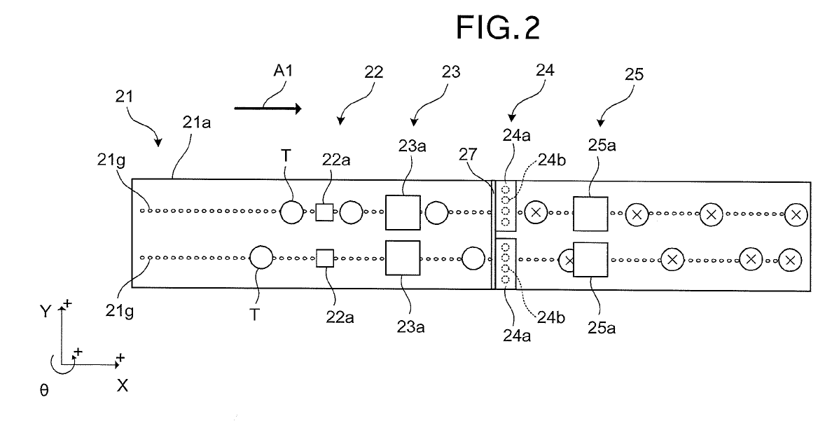

The conveying device 21 includes a conveyor belt 21a, a pulley body 21b as a driving pulley, a plurality of driven pulleys 21c (three in the example of FIG. 1), a motor (driving unit) 21d, a position detector 21e, and a suction chamber 21f. The conveyor belt 21a is formed to be endless and wrapped around the pulley body 21b and each of the driven pulleys 21c. The pulley body 21b and the driven pulleys 21c are rotatably provided to the apparatus main body, and the pulley body 21b is connected to the motor 21d. The motor 21d is electrically connected to the control device 50, and is driven under the control of the control device 50. The position detector 21e is a device such as an encoder and is attached to the motor 21d. The position detector 21e is electrically connected to the control device 50, and sends a detection signal to the control device 50. The control device 50 can obtain information such as the position, speed, and movement amount of the conveyor belt 21a based on the detection signal. In the conveying device 21, the conveyor belt 21a is rotated together with the driven pulleys 21c due to the rotation of the pulley body 21b by the motor 21d, and the tablets T on the conveyor belt 21a are conveyed in the direction of the arrow A1 in FIGS. 1 and 2 (conveying direction A1).

As illustrated in FIG. 2, a plurality of circular suction holes 21g are formed on the surface of the conveyor belt 21a. The suction holes 21g are through holes for sucking and holding each of the tablets T, and are arranged in two rows in parallel along the conveying direction A1 so as to form two conveying paths. Each of the suction holes 21g is connected to the suction chamber 21f (see FIG. 1) to obtain suction force from the suction chamber 21f. The suction chamber 21f is configured to give (apply) suction force to the tablets T placed in the suction holes 21g of the conveyor belt 21a. A suction device such as a pump is connected to the suction chamber 21f via a suction pipe (not illustrated), and the inside of the suction chamber 21f is depressurized by the operation of the suction device. The suction pipe is connected to substantially the center of a side surface (a surface parallel to the conveying direction A1) of the suction chamber 21f. The suction device is electrically connected to the control device 50, and is driven under the control of the control device 50.

The detecting device 22 includes a plurality of detectors 22a (two in the example of FIG. 2). Each of the detectors 22a is arranged on the downstream side in the conveying direction A1 from the position where the tablet T on the conveyor belt 21a is supplied by the supply device 10 for each conveying path of the tablets T in a direction intersecting the conveying direction A1 in the horizontal plane (for example, a direction perpendicular to the conveying direction A1), and is located above the conveyor belt 21a. The detector 22a detects the position (the position in the conveying direction A1) of the tablet T on the conveyor belt 21a by projecting and receiving laser beams, and functions as a trigger sensor of each device located on the downstream side. As the detector 22a, various laser sensors such as a reflection laser sensor can be used. Each of the detectors 22a is electrically connected to the control device 50, and sends a detection signal to the control device 50.

The first imaging device 23 includes a plurality of imaging units 23a (two in the example of FIG. 2). Each of the imaging units 23a is arranged on the downstream side in the conveying direction A1 from the position where the detecting device 22 is provided for each conveying path of the tablets T in a direction intersecting the conveying direction A1 in the horizontal plane (for example, a direction perpendicular to the conveying direction A1), and is located above the conveyor belt 21a. The imaging unit 23a performs imaging at the time when the tablet T reaches just under the imaging unit 23a based on the position information of the tablet T to capture an image (image for printing) including the upper surface of the tablet T, and sends the image to the control device 50. As the imaging unit 23a, various cameras having an imaging device such as a charge-coupled device (CCD) or a complementary metal-oxide semiconductor (CMOS) can be used. Each of the imaging units 23a is electrically connected to the control device 50, and is driven under the control of the control device 50. There may also be provided an illumination for imaging as necessary.

The print head device 24 includes a plurality of ink jet print heads 24a (two in the example of FIG. 2). Each of the print heads 24a is arranged on the downstream side in the conveying direction A1 from the position where the first imaging device 23 is provided for each conveying path of the tablets T in a direction intersecting the conveying direction A1 in the horizontal plane (for example, a direction perpendicular to the conveying direction A1), and is located above the conveyor belt 21a. The print head 24a has a plurality of nozzles 24b (see FIG. 2: only four nozzles are illustrated in the figure), and ejects ink individually from each of the nozzles 24b. In the print head 24a, the surface on which the nozzles 24b are formed is the nozzle surface M1 (see FIG. 1). The print head 24a is arranged so that the alignment direction of the nozzles 24b intersects (for example, orthogonally to) the conveying direction A1 in the horizontal plane. As the print head 24a, various ink jet print heads having a drive element such as a piezoelectric element, a heating element, a magnetostrictive element or the like can be used. Each of the print heads 24a is electrically connected to the control device 50, and is driven under the control of the control device 50.

The second imaging device 25 includes a plurality of imaging units 25a (two in the example of FIG. 2). Each of the imaging units 25a is arranged on the downstream side in the conveying direction A1 from the position where the print head device 24 is provided for each conveying path of the tablets T in a direction intersecting the conveying direction A1 in the horizontal plane (for example, a direction perpendicular to the conveying direction A1), and is located above the conveyor belt 21a. The imaging unit 25a performs imaging at the time when the tablet T reaches just under the imaging unit 25a based on the position information of the tablet T to capture an image (image for inspection) including the upper surface of the tablet T, and sends the image to the control device 50. Similarly to the imaging unit 23a, as the imaging unit 25a, various cameras having an imaging device such as CCD or CMOS can be used. Each of the imaging units 25a is electrically connected to the control device 50, and is driven under the control of the control device 50. There may also be provided an illumination for imaging as necessary.

Referring back to FIG. 1, the drying device 26 is located downstream of the set position of the second imaging device 25 in the conveying direction A1, and is located, for example, below the conveying device 21. The drying device 26 is shared in the two conveying paths, and is configured to dry the ink applied to each tablet T on the conveyor belt 21a. As the drying device 26, various types of drying units such as a heater for drying an object to be dried by radiation heat, a blower for drying an object to be dried with worm air or hot air, and the like can be used. The drying device 26 is electrically connected to the control device 50, and is driven under the control of the control device 50.

The tablet T passing above the drying device 26 is conveyed along with the movement of the conveyor belt 21a and reaches a position near an end portion of the conveyor belt 21a on the driven pulley 21c side. At this position, the suction does not work on the tablet T. The tablet T is released from the hold of the conveyor belt 21a, and is transferred from the first printing device 20 to the second printing device 30.

The second printing device 30 includes a conveying device 31, a detecting device 32, a first imaging device (imaging device for printing) 33, a print head device 34, a second imaging device (imaging device for inspection) 35, and a drying device 36. The conveying device 31 includes a conveyor belt 31a, a pulley body 31b as a driving pulley, a plurality of driven pulleys 31c (three in the example of FIG. 1), a motor (driving unit) 31d, a position detector 31e, and a suction chamber 31f. Each constituent element of the second printing device 30 has basically the same structure as the corresponding constituent element of the first printing device 20 described above. Therefore, the explanation will be omitted. The conveying direction of the second printing device 30 is the direction of the arrow A2 (conveying direction A2) in FIG. 1.

The collecting device 40 includes a defective product collecting device 41 and a non-defective product collecting device 42. The collecting device 40 is located on the downstream side in the conveying direction A2 from the set position of the drying device 36 of the second printing device 30. The collecting device 40 collects defective tablets T by the defective product collecting device 41 and collects good tablets T by the non-defective product collecting device 42.

The defective product collecting device 41 includes an injection nozzle 41a and a housing 41b. The injection nozzle 41a is provided in the suction chamber 31f of the second printing device 30. The injection nozzle 41a injects a gas (for example, air) toward the tablet T (defective tablet T) conveyed by the conveyor belt 31a such that the tablet T is dropped from the conveyor belt 31a. At this time, the gas injected from the injection nozzle 41a passes through the suction holes (similar to the suction holes 21g illustrated in FIG. 2) of the conveyor belt 31a and hits the tablet T. The injection nozzle 41a is electrically connected to the control device 50, and is driven under the control of the control device 50. The housing 41b receives and stores the tablet T dropped from the conveyor belt 31a.

The non-defective product collecting device 42 includes a gas blower 42a and a housing 42b. The non-defective product collecting device 42 is located on the downstream side in the conveying direction A2 from the set position of the defective product collecting device 41. The gas blower 42a is provided at the end portion of the conveying device 31 in the conveying device 31 of the second printing device 30, that is, at the end portion of the conveyor belt 31a on the driven pulleys 31c side. During the printing process, for example, the gas blower 42a constantly blows a gas (for example, air) toward the conveyor belt 31a to drop the tablet T from the conveyor belt 31a. At this time, the gas blown out from the gas blower 42a passes through the suction holes (similar to the suction holes 21g illustrated in FIG. 2) of the conveyor belt 31a and hits the tablet T. Examples of the gas blower 42a include an air blow having a slit-shaped opening extending in a direction intersecting the conveying direction A2 in the horizontal plane (for example, a direction perpendicular to the conveying direction A2) in the conveying direction A2. The gas blower 42a is electrically connected to the control device 50, and is driven under the control of the control device 50. The housing 42b receives and stores the tablet T dropped from the conveyor belt 31a.

The tablet T having passed through the defective product collecting device 41 is conveyed along with the movement of the conveyor belt 31a, and reaches a position near the end portion of the conveyor belt 31a on the driven pulleys 31c side. At this position, the suction does not work on the tablet T. However, with the gas blower 42a, the tablet T can be reliably dropped from the conveyor belt 31a and collected in the housing 42b.

The control device 50 includes an image processing unit 51, a print processing unit 52, an inspection processing unit 53, and a storage 54. The image processing unit 51 processes an image. The print processing unit 52 performs processing related to printing. The inspection processing unit 53 performs processing related to inspection. The storage 54 stores various information such as processing information and various programs. The control device 50 controls the supply device 10, the first printing device 20, and the second printing device 30. The control device 50 receives position information of the tablets T sent from each of the detecting devices 22 and 32 of the first printing device 20 and the second printing device 30, images sent from each of the imaging devices 23, 25, 33 and 35 of the first printing device 20 and the second printing device 30, and the like.

### (Control Plate)

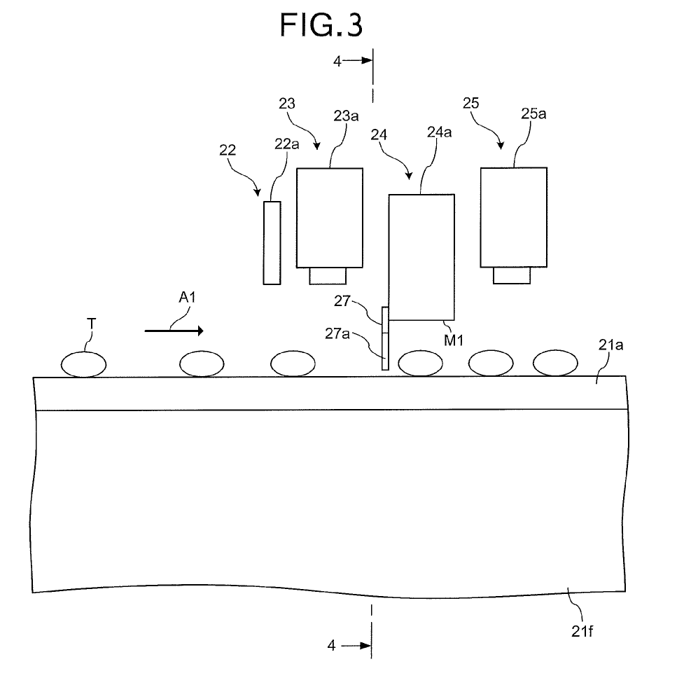

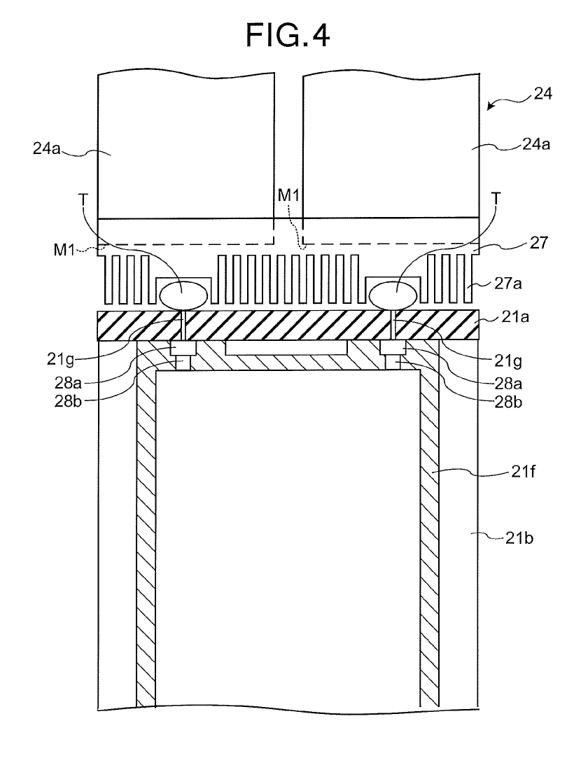

As illustrated in FIGS. 1 and 2, each of the print heads 24a of the print head device 24 is provided with a common control plate 27. The control plate 27 will be described with reference to FIGS. 3 and 4. A control plate 37 (see FIG. 1) for the print head device 34 of the second printing device 30 is of basically the same structure, and therefore the description thereof will be omitted.

As illustrated in FIGS. 3 and 4, the control plate 27 is formed in, for example, a rectangular plate shape. The longitudinal direction of the control plate 27 is set in a direction perpendicular to the conveying direction A1 of the tablet T in the horizontal plane. Further, the control plate 27 is set perpendicular to the lower surface (nozzle surface M1) of each of the print heads 24a, and is arranged on a surface of each of the print heads 24a on the upstream side in the conveying direction A1 (conveying direction upstream side). The control plate 27 is located between the height position of the nozzle surface M1 of the print heads 24a and the conveyor belt 21a. An end portion of the control plate 27 on the conveyor belt 21a side is formed in a comb shape having a plurality of comb teeth 27a arranged in a direction perpendicular to the conveying direction A1 in the horizontal plane. Each of the comb teeth 27a is formed into, for example, a quadrangular prism shape. The control plate 27 is located on the upstream side of each of the print heads 24a in the conveying direction A1 and controls an airflow generated between the conveyor belt 21a and each of the print heads 24a.

The length of the control plate 27 in the longitudinal direction (the length in a direction perpendicular to the conveying direction A1 in the horizontal plane) is equal to or longer than the length of the row of all the nozzles 24b of each of the print heads 24a. The thickness of the control plate 27, that is, the length in the short side direction (the length in a direction along the conveying direction A1) is, for example, about 2 mm. The vertical distance between the lower end of the comb teeth 27a and the upper surface of the conveyor belt 21a is, for example, about 1 mm. The lower end of the comb teeth 27a is higher than the upper surface of the conveyor belt 21a, and lower than the apex of the tablet T placed on the upper surface of the conveyor belt 21a. The length of the comb teeth 27a in the short side direction (the length in a direction perpendicular to the conveying direction A1 in the horizontal plane) is, for example, about 2 mm. The horizontal distance between two adjacent teeth of the comb teeth 27a, which sandwich the tablet T conveyed by the conveyor belt 21a, depends on the diameter of the tablet T to be printed (an example of the maximum size of the tablet T in the horizontal direction) and is larger than the diameter. That is, the control plate 27 is shaped so as not to hit the tablet T conveyed by the conveyor belt 21a. The diameter of the tablet T varies depending on the type of the tablet T, and may be, for example, about 5 mm to 12 mm.

A metal such as stainless steel (SUS) can be used as a material of the control plate 27. The control plate 27 may be made of any material other than SUS such as, for example, aluminum or resin as long as that conforms to the Food Sanitation Law.

In this embodiment, only one control plate 27 is provided to be shared by the print heads 24a arranged in two rows; however, it is not so limited. Control plates 27 may be provided one for each of the print heads 24a. Besides, all of the comb teeth 27a are formed in a quadrangular prism shape; however, it is not so limited. The comb teeth 27a may be formed in, for example, a triangular prism shape, a hexagonal prism shape, a cylindrical shape, or an elliptic cylinder shape. In addition, all of the comb teeth 27a need not necessarily be formed in the same shape, and a part of the comb teeth 27a may have a different shape, or the comb teeth 27a may each have a different shape.

As illustrated in FIG. 4, each of the suction holes 21g of the conveyor belt 21a is connected to the inside of the suction chamber 21f via a groove 28a formed in the suction chamber 21f and a plurality of through holes 28b. The groove 28a is formed for each conveying path of the tablet T so as to be located immediately below each of the suction holes 21g of the conveyor belt 21a wrapped around the pulley body 21b and the driven pulleys 21c. Each of the through holes 28b is formed in the bottom surface of the groove 28a so as to be aligned in the conveying direction A1. When the inside of the suction chamber 21f is sucked, the tablets T on the suction holes 21g are sucked through the groove 28a and the through holes 28b.

As illustrated in FIG. 4, the longitudinal length of the control plate 27 (the length in a direction perpendicular to the conveying direction A1 in the horizontal plane) is equal to or longer than the length of the tablet T to be printed in the same direction (the length in a direction perpendicular to the conveying direction A1 in the horizontal plane). Therefore, when the tablet T is conveyed while being sucked on the suction hole 21g, the conveying path is covered by the control plate 27 when the tablet T passes under the control plate 27. In addition, for example, when the tablet T has a disc shape, the “length in the same direction” corresponds to the diameter of the tablet T.

### (Printing Process)

Next, a description will be given of printing process and inspection process performed by the tablet printing apparatus 1.

First, various information such as print data required for printing is stored in the storage 54 of the control device 50. Then, when a number of tablets T to be printed are put in the hopper 11 of the supply device 10, the tablets T are sequentially supplied from the hopper 11 to the alignment feeder 12, and moved as being aligned in two rows by the alignment feeder 12. The tablets T moving in two rows are sequentially supplied to the conveyor belt 21a by the transfer feeder 13. The conveyor belt 21a is rotating in the conveying direction A1 with the rotation of the pulley body 21b and the driven pulleys 21c by the motor 21d. Accordingly, the tablets T supplied onto the conveyor belt 21a are conveyed at a predetermined moving speed in two rows on the conveyor belt 21a. The conveyor belt 31a is also rotated in the conveying direction A2 with the rotation of the pulley body 31b and the driven pulleys 31c by the motor 31d.

Thereafter, the tablet T on the conveyor belt 21a is detected by the detecting device 22. Thereby, position information (the position in the conveying direction A1) of the tablet T is acquired and input to the control device 50. The position information of the tablet T is stored in the storage 54 and used for post-processing. Next, an image of the tablet T on the conveyor belt 21a is captured by the first imaging device 23 at the timing based on the position information of the tablet T, and the image captured is sent to the control device 50. Based on each image sent from the first imaging device 23, positional shift information of the tablet T (for example, positional shift of the tablet T in the X direction, the Y direction, and the θ direction) is generated by the image processing unit 51, and is stored in the storage 54. Based on the positional shift information of the tablet T, printing conditions (ejection position and ejection speed of the ink) for the tablet T are set by the print processing unit 52 and stored in the storage 54.

Subsequently, the print head device 24 performs printing on each of the tablets T on the conveyor belt 21a based on the printing conditions at the timing based on the position information of the tablet T, that is, at the timing when the tablet T reaches below the print head device 24. In each of the print heads 24a of the print head device 24, ink is appropriately ejected from each of the nozzles 24b, Thus, identification information such as a letter (for example, alphabet, kana, number), a mark (for example, symbol or figure), or the like is printed on the top surface of the tablets T.

The tablet T on which the identification information is printed is imaged by the second imaging device 25 at the timing based on the position information of the tablet T, and the image is sent to the control device 50. The image processing unit 51 generates print position information indicating the print position of the print pattern for each tablet T based on each image sent from the second imaging device 25. The print position information is stored in the storage 54. The inspection processing unit 53 determines whether the printing on the tablet T is acceptable based on the print position information, and print quality determination result information indicating the result of print quality determination is stored in the storage 54 for each tablet T. For example, it is determined whether the print pattern is printed at a predetermined position of the tablet T.

The tablet T after the inspection is conveyed along with the movement of the conveyor belt 21a and passes above the drying device 26. At this time, the drying device 26 dries the ink applied to the tablet T while the tablet T is passing above the drying device 26. The tablet T where the ink has dried is conveyed with the movement of the conveyor belt 21a and is located near the end portion of the conveyor belt 21a on the driven pulley 21c side. At this position, the suction no longer works on the tablet T. The tablet T is released from the hold of the conveyor belt 21a, and is transferred from the first printing device 20 to the second printing device 30.

After that, the printing process and the inspection process are performed in the same manner as described above also in the second printing device 30. The tablet T after the inspection is conveyed with the movement of the conveyor belt 31a and passes above the drying device 36. Then, the tablet T with the ink dried reaches the defective product collecting device 41. The defective tablet T is dropped from the conveyor belt 31a by the gas ejected from the injection nozzle 41a and collected in the housing 41b. On the other hand, the non-defective tablet T passes through the defective product collecting device 41 and reaches the non-defective product collecting device 42. At this position, the suction does not work on the tablet T, and the non-defective tablet T drops away from the conveyor belt 31a by the gas blown out from the gas blower 42a, and is collected in the housing 42b.

In the printing process, the tablet T supplied onto the suction hole 21g is held on the conveyor belt 21a by suction from the suction hole 21g. However, the suction hole 21g may not be completely closed by the tablet T. In this case, since air is sucked from the suction hole 21g, an airflow is generated above the suction hole 21g. When the tablet T is conveyed, an airflow flowing above the conveyor belt 21a also occurs along the conveying direction A1 by the movement of the conveyor belt 21a. In addition, if the print head 24a and its surrounding members are located above the conveyor belt 21a, the airflow flowing above the conveyor belt 21a strikes these members, which generates further turbulence.

Although airflows are generated as above, an airflow generated below each of the print heads 24a and around it is controlled by the control plate 27. That is, the control plate 27 controls the airflow by having a blocking portion where the airflow generated between the conveyor belt 21a and the print head 24a along the conveying direction A1 by the movement of the conveyor belt 21a is blocked and an opening portion through which the airflow passes. In the example of this embodiment, the comb teeth 27a serves as the blocking portion, and a space in the comb teeth 27a corresponds to the opening portion. For example, the airflow flowing above the conveyor belt 21a along the conveying direction A1 strikes the control plate 27 and passes though the comb teeth 27a of the control plate 27. As a result, the airflow generated between the conveyor belt 21a and each of the print heads 24a is controlled, and powder adhering to the tablet T and the conveyor belt 21a is suppressed from being blown by the airflow generated below the print heads 24a and its surroundings. Thus, the powder is suppressed from adhering to the lower surface (nozzle surface) of the print heads 24a. On the upstream side of the control plate 27, even if the powder adhering to the tablet T and the conveyor belt 21a is blown by the airflow, a part of the powder is blocked by the control plate 27. As a result, the powder can be suppressed from adhering to the lower surface of the print head 24a.

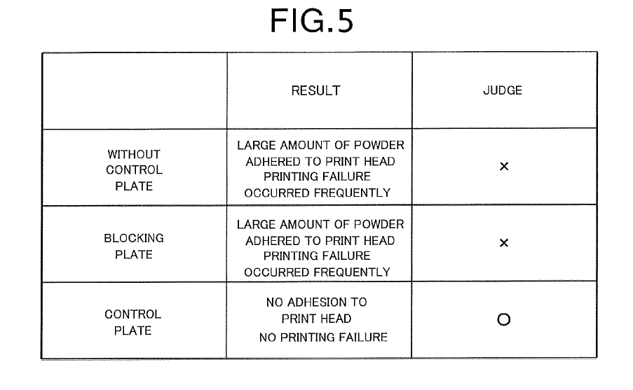

FIG. 5 illustrates a result of comparison among a conventional tablet printing apparatus not having the control plate 27, a tablet printing apparatus having a blocking plate without the comb teeth 27a of the control plate 27, the tablet printing apparatus 1 of this embodiment in which the control plate 27 is made of resin, and the tablet printing apparatus 1 of this embodiment in which the control plate 27 is made of metal when printing was performed on the tablet T for 30 minutes. The amount of powder adhering to the print head 24a was visually observed, and the incidence of tablet T with printing failure was also observed.

First, in the conventional tablet printing apparatus not having the control plate 27, a large amount of powder adhered to the print head 24a, and there were many tablets T with printing failure.

Next, in the tablet printing apparatus having the blocking plate without the comb teeth 27a of the control plate 27, similarly to the conventional tablet printing apparatus, a large amount of powder adhered to the print head 24a, and there were many tablets T with printing failure. Presumably, this may be because most of airflows generated above the suction holes 21g hit the blocking plate not having the comb teeth 27a, resulting in the generation of turbulence, and the flow velocity increased in the space between the blocking plate and the conveyor belt 21a, resulting in the further generation of airflows below the print head 24a, and thus the powder was blown up.

In the tablet printing apparatus 1 of this embodiment with the resinous control plate 27, the adhesion of powder was scarcely observed on the print head 24a, and there was no tablet T having printing failure. Besides, the adhesion of powder was observed on the control plate 27.

In the tablet printing apparatus 1 of this embodiment with the metallic control plate 27, the adhesion of powder was scarcely observed on the print head 24a, and there was no tablet T having printing failure. In addition, no adhesion of powder was observed on the control plate 27.

When the tablet T conveyed as being sucked on the conveyor belt 21a is swayed by the airflow generated between the conveyor belt 21a and each of the print heads 24a, the posture of the printing surface of the tablet T may not be maintained. Further, since the tablet T is in a three-dimensional shape and has a thickness, when the tablet T passes under the print head 24a, the distance between the nozzle surface M1 of the print head 24a and the printing surface of the tablet T is shorter than the distance between the nozzle surface M1 and the upper surface of the conveyor belt 21a where the tablet T is not sucked. For example, the distance between the nozzle surface M1 of the print head 24a and the printing surface of the tablet T is 20% to 25% (in a range of 20% or more and 25% or less) of the distance between the nozzle surface M1 and the upper surface of the conveyor belt 21a where the tablet T is not sucked.

Consequently, the posture of the printing surface of the tablet T is susceptible to turbulence generated by sudden pressure fluctuation caused when the tablet T passes under the print head 24a and turbulence generated near the print head 24a as a result of the collision of the airflow flowing above the conveyor belt 21a with the print head 24a. If the posture of the printing surface of the tablet T cannot be maintained due to the influence of such airflow, the print position may be shifted or the print may be blurred, thereby causing a printing failure. Therefore, it is necessary to control the airflow also on the surface of the conveyor belt 21a around the print head 24a.

As described above, the airflow flowing above the conveyor belt 21a along the conveying direction A1 hits the control plate 27 and passes through the opening portion in the control plate 27. This rectifies the airflow flowing above the conveyor belt 21a into a laminar flow along the conveying direction A1.

The longitudinal length of the control plate 27 (the length in a direction perpendicular to the conveying direction A1 in the horizontal plane) is equal to or longer than the length of the tablet T to be printed in the same direction (the length in a direction perpendicular to the conveying direction A1 in the horizontal plane). Therefore, the control plate is arranged so as to cover the conveying path of the tablet T on the conveyor belt 21a. Thereby, the airflow flowing above the conveyor belt 21a can be rectified into a laminar flow along the conveying direction A1.

The control plate 27 is shaped so as not to hit the tablets T conveyed by the conveyor belt 21a. A part of the lower end of the control plate 27 is located at a position higher than the upper surface of the conveyor belt 21a and lower than the apex of the tablet T on the conveyor belt 21a. Thus, it is possible to rectify the airflow around the surface of the conveyor belt 21a into a laminar flow without hindering the conveyance of the tablet T.

As described above, according to the first embodiment, the control plate 27 that controls the airflow generated between the conveyor belt 21a and the print head 24a is located on the upstream side of the print head 24a in the conveying direction A1 above the conveyor belt 21a. With this, the airflow generated below and around each of the print heads 24a is controlled. Thus, the powder adhering to the tablets T and the conveyor belt 21a is prevented from being blown by the airflow generated below and around each of the print heads 24a. Even if the powder adhering to the tablets T and the conveyor belt 21a flies due to the airflow, a part of the powder is blocked by the control plate 27. Thereby, the powder can be prevented from adhering to the lower surface of the print head 24a. Therefore, it is possible to suppress the adhesion of the powder of the tablet T to the lower surface of the print head 24a as well as to reduce erroneous flight direction and the defective ejection of ink from the print head 24a. As a result, a reduction in print quality due to the powder of the tablets T can be suppressed.

Further, it is possible to rectify the airflow on the conveyor belt 21a below and around the print head 24a into a laminar flow, thereby suppressing the occurrence of turbulence. With this, the shaking of the tablet T sucked and held by the conveyor belt 21a can be suppressed. Thus, it is possible to suppress a reduction in print quality due to the inability to maintain the posture of the print surface of the tablet T.

Although the control plate 27 is arranged in the print head 24a, it is not so limited. The control plate 27 may be arranged in another member (refer to second and third embodiments below). If the control plate 27 is arranged in the print head 24a, when the type of the tablets T to be printed is changed and there is a change in the thickness of the tablets T, by adjusting the height position of the print head 24a, the height position of the control plate 27 is automatically adjusted simultaneously with the adjustment of the height position. When the control plate 27 is arranged in a member other than the print head 24a, the height position of the print head 24a and the height position of the control plate 27 need to be individually adjusted. However, when the control plate 27 is arranged in the print head 24a, the height position of the print head 24a and the height position of the control plate 27 can be adjusted simultaneously according to the thickness of the tablets T. Thus, effective adjustment can be realized.

### Second Embodiment

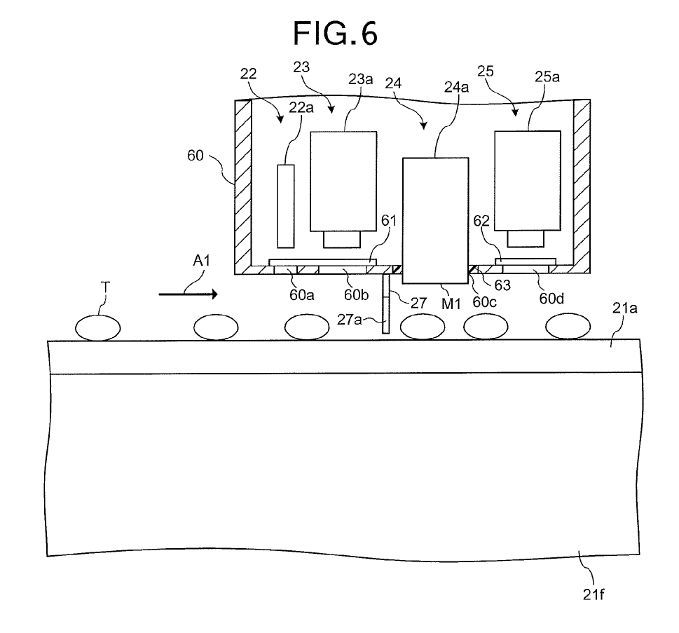

Next, a second embodiment will be described with reference to FIG. 6. The second embodiment is different from the first embodiment in the presence of a cover 60, and the cover 60 will be described. Other explanation will be omitted.

As illustrated in FIG. 6, in the second embodiment, there is provided the cover 60. The cover is a housing configured to house the detecting device 22 (the two detectors 22a), the first imaging device 23 (the two imaging units 23a), the print head device 24 (the two print heads 24a), and the second imaging device 25 (the two imaging units 25a). The cover 60 is arranged above the conveyor belt 21a at a predetermined distance (for example, 5 mm to 12 mm) from the upper surface of the conveyor belt 21a according to the thickness of the tablet T (for example, 2 mm to 4 mm) such that the lower surface of the cover 60 does not contact the tablet T conveyed by the conveyor belt 21a.

On the lower surface of the cover 60, two through holes 60a are formed in a direction perpendicular to the conveying direction A1 in the horizontal plane so that each of the detectors 22a in the cover 60 can detect the tablet T on the conveyor belt 21a. Besides, two through holes 60b are formed in the same direction as the alignment of the through holes 60a so that each of the imaging units 23a in the cover 60 can capture an image of the tablet T on the conveyor belt 21a. Further, on the lower surface of the cover 60, two through holes 60c are formed in the same direction as the alignment of the through holes 60a so that each of the print heads 24a in the cover can perform printing on the tablet T on the conveyor belt 21a. In addition, two through holes 60d are formed in the same direction as the alignment of the through holes 60a so that each of the imaging units 25a in the cover 60 can capture an image of the tablet T on the conveyor belt 21a.

Each of the through holes 60a, 60b, and 60d is covered with transparent members 61 and 62 such as glass provided to the bottom surface of the inside of the cover 60. The print head 24a is inserted into each of the through holes 60c via a sealing member 63 such as silicon to close the through holes 60c. In this manner, the cover 60 is formed to be sealed, and the inside of the cover 60 is maintained at a positive pressure.

On the lower surface of the cover 60, the control plate 27 is arranged between the imaging units 23a and the print heads 24a (at least on the upstream side of the print heads 24a in the conveying direction A1 of the tablets T). As in the first embodiment, the control plate 27 enables the control of the airflow generated between the conveyor belt 21a and each of the print heads 24a. Thus, a reduction in print quality due to the powder of the tablets T can be suppressed.

Further, according to the second embodiment, when the operation of the tablet printing apparatus 1 is stopped and the entire apparatus is cleaned, by removing the cover 60, the control plate 27 attached to the cover 60 can also be detached. Thereby, the cover 60 and the control plate 27 can be cleaned at once. Thus, the cleaning can be performed efficiently. On the other hand, the detecting device 22, the first imaging device 23, and the second imaging device 25 are covered with the cover 60. Therefore, powder does not adhere to these devices, and there is no need to clean them. Thus, the cleaning can be simplified.

### Third Embodiment

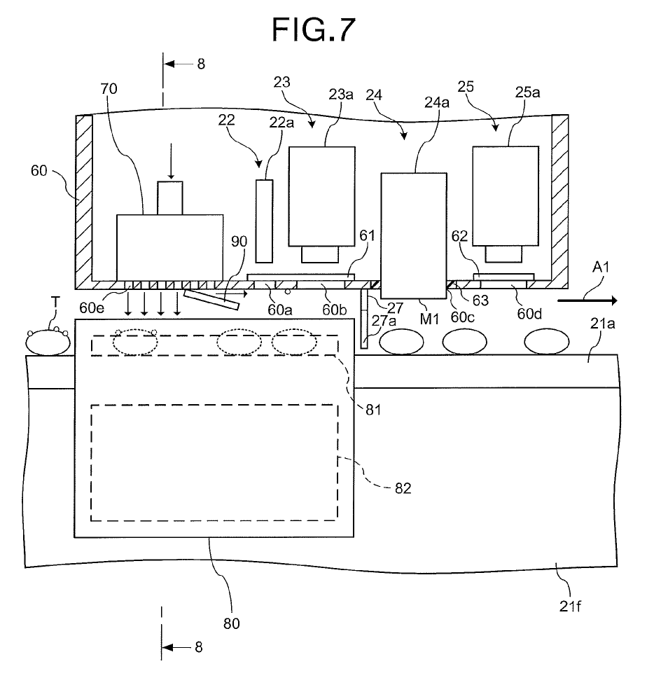

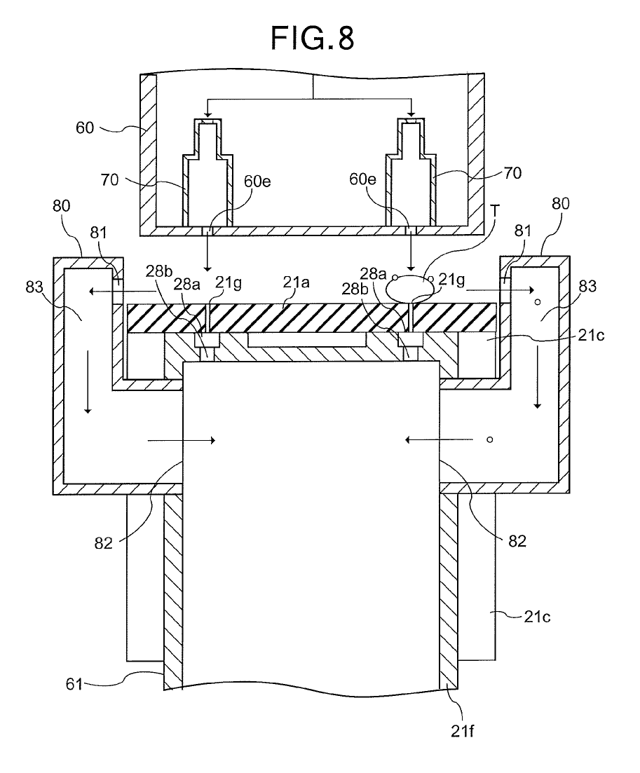

Next, a third embodiment will be described with reference to FIGS. 7 and 8. In the third embodiment, differences from the second embodiment (gas blower and gas suction unit) will be described. Other explanation will be omitted.

As illustrated in FIGS. 7 and 8, in the third embodiment, in addition to the cover 60, there are provided two gas blowers 70 and two gas suction units 80. Each of the gas blowers 70 and each of the gas suction units 80 function as a deposit removing mechanism. The deposit removing mechanism blows a gas (for example, air or inert gas) against deposits (for example, powder and dust) adhering to the tablet T on the conveyor belt 21a or the lower surface of the cover 60 to blow off the deposits from the tablet T or the lower surface of the cover 60. The blown off deposits are sucked together with air, and thus removed from the tablet T or the lower surface of the cover 60. Also, as the tablets T are conveyed by the conveyor belt 21a, the powder of the tablets T may sometimes fly in the apparatus. The gas blowers 70 and the gas suction units 80 also remove the powder flying in the apparatus, in particular the powder flying around the cover 60.

In addition to the detecting device 22, the first imaging device 23, the print head device 24, and the second imaging device 25, the cover 60 is a housing that houses the two gas blowers 70. As in the second embodiment, the cover 60 is arranged above the conveyor belt 21a at a predetermined distance from the upper surface of the conveyor belt 21a according to the thickness of the tablet T such that the lower surface thereof does not contact the tablet T conveyed by the conveyor belt 21a. On the lower surface of the cover 60, as in the second embodiment, the control plate 27 is arranged between the imaging units 23a and the print head 24a. The control plate 27 enables the control of the airflow generated between the conveyor belt 21a and each of the print heads 24a. Thus, a reduction in print quality due to the powder of the tablets T can be suppressed.

A plurality of through holes 60e are formed in the lower surface of the cover 60 so that each of the gas blowers 70 in the cover 60 can blow gas against the upper surface of the conveyor belt 21a. The through holes 60e are formed, for example, in an array in the conveying direction A1 with respect to each of the gas blowers 70. The gas blown out from the gas blowers 70 passes through the through holes 60e that penetrate the lower surface of the cover 60, and is blown onto the conveyor belt 21a. For example, the diameter of the through holes 60e is a few mm (for example, about 2 mm). Each of the through holes 60e is covered with each of the gas blowers 70 arranged on the bottom surface of the inside of the cover 60. In this manner, the cover 60 is formed to be sealed, and the inside of the cover 60 is maintained at a positive pressure.

The gas blowers 70 are each connected to each of the through holes 60e in the lower surface of the cover 60, and blow gas from the through holes 60e against the conveyor belt 21a. As a result, when the tablets T on the conveyor belt 21a pass under the gas blowers 70, the gas is blown against the tablets T on the conveyor belt 21a, and the deposits adhering to the upper surface of the conveyor belt 21a and the tablets T are blown away from tablets T. Each of the gas blowers 70 is connected to a gas supply unit via a flow regulating valve (not illustrated), and gas is supplied from the gas supply unit to each of the gas blowers 70.

Further, on the lower surface of the cover 60, guide plates 90 are provided for each of the gas blowers 70 and located on the downstream side in the conveying direction A1 below the gas blowers 70. The guide plates 90 are formed in a rectangular shape, the longitudinal direction of which is parallel to a direction perpendicular to the conveying direction A1 in the horizontal plane, and are tilted down to the print head device 24 side. The guide plate 90 flows a part of the gas blown out from the gas blowers 70 through each of the through holes 60e toward the downstream side in the conveying direction A1 to generate an airflow flowing in the conveying direction A1 along the lower surface of the cover 60. With this, gas is blown to deposits adhering to the lower surface of the cover 60, and the deposits are blown away from the lower surface of the cover 60. Although the guide plates 90 are described as being provided one for each of the gas blowers 70 arranged in two rows, it is not so limited. One guide plate 90 may be shared as a common member.

The gas suction units 80 are each arranged adjacent to the side surface of the conveyor belt 21a such that the conveyor belt 21a is located between them, and are attached to the suction chamber 21f. The gas suction units 80 each include an inlet port 81, an outlet port 82, and an internal flow path 83 (see FIG. 8).

The inlet port 81 and the outlet port 82 are formed in a rectangular shape (slit shape) extending in the conveying direction A1. The inlet port 81 is an opening for sucking air from the space between the upper surface of the conveyor belt 21a and the lower surface of the cover 60. The inlet port 81 is located on the conveyor belt 21a side in the gas suction unit 80 at a position higher than the upper surface of the conveyor belt 21a. The opening of the inlet port 81 is provided such that the terminal end thereof is located upstream of the control plate 27 in the conveying direction A1. Thereby, gas from the gas blowers 70 does not flow to each of the print heads 24a. Thus, the nozzles 24b of each of the print heads 24a are prevented from drying and causing ejection failure, and the ink ejected from the nozzles 24b is prevented from being influenced by the airflow and resulting in the ejection direction disorder. The outlet port 82 is located on the conveyor belt 21a side in the gas suction unit 80 at a position lower than the conveyor belt 21a, and is connected to the inside of the suction chamber 21f. The internal flow path 83 is formed inside the gas suction unit 80 and is a flow path that connects the inlet port 81 and the outlet port 82.

When the inside of the suction chamber 21f is sucked for conveying the tablet T, air is sucked from the outlet port 82 in each of the gas suction units 80. Then, air in the space between the upper surface of the conveyor belt 21a and the lower surface of the cover 60 is sucked from the inlet port 81 via the internal flow path 83 connected to the outlet port 82. As a result, deposits blown off by the gas from the gas blowers 70 are sucked together with the air from the inlet port 81.

The suction force of the gas suction unit 80 can be adjusted by changing the length of the inlet port in the height direction. However, it is desirable that the length of the inlet port 81 in the height direction be shorter than the height of the tablet T. Normally, the suction force for sucking air from the inlet port 81 is not set to the one by which the tablet T is sucked through the inlet port 81. However, if the adjustment of the suction force is insufficient or the type of the tablets T is changed (the tablets T having different sizes), there is a concern that the tablets T may be sucked through the inlet port 81. Therefore, by making the length of the inlet port 81 in the height direction shorter than the height of the tablet T, the tablet T can be prevented from being sucked through the inlet port 81. The longitudinal length of the inlet port 81 is appropriately set based on the suction range required to remove deposits adhering to the tablets T on the conveyor belt 21a.

Further, the amount of gas from the gas blowers 70 and the suction force of air from the inlet port 81 are set such that the position of the tablet T (including the position of the tablet T in the X direction, the Y direction, and the θ direction, the posture such as the inclination of the tablet T, etc.) does not change on the conveyor belt 21a and the tablet T does not fall from the conveyor belt 21a due to the gas from the gas blowers 70 and the suction force by which the air is sucked from the inlet port 81.

Blowing of gas from the gas blowers 70 and suction of air from the gas suction units 80 are always performed during the operation of the tablet printing apparatus 1. Even if the tablet T does not arrive at the gas blowers 70, the detecting device 22, the first imaging device 23, or the print head device 24 for a certain period of time, gas is blown from the gas blowers 70 and air is sucked from the gas suction units 80. Thereby, powder adhering to the conveyor belt 21a can be removed, and powder is prevented from adhering to the conveyor belt 21a. If a large amount of powder of the tablets T adheres to the conveyor belt 21a or the transparent member 61, the first imaging device 23 may photograph a portion where the powder accumulates. This may result in that erroneous detection takes place irrespective of the fact that there is no tablet T, and printing is carried out on the conveyor belt 21a. However, by constantly blowing gas from the gas blowers 70 and sucking air from the gas suction units 80, such erroneous detection can be prevented.

Besides, when tablets T are newly supplied in a state where powder is adhered onto the conveyor belt 21a, the tablets T slide on the conveyor belt 21a and fall from the conveyor belt 21a, or the posture of the tablets T changes on the conveyor belt 21a. Sliding of the tablets T on the conveyor belt 21a at the time of restarting the conveyance of the tablets T can also be suppressed by constantly blowing and sucking gas by the deposit removing mechanism during the operation of the tablet printing apparatus 1.

In the configuration as described above, when printing is performed on the tablets T, gas is blown out from each of the through holes 60e onto the conveyor belt 21a by each of the gas blowers 70. Further, the air in the suction chamber 21f is sucked, and accordingly, the air in the space between the upper surface of the conveyor belt 21a and the lower surface of the cover 60 is sucked from the individual inlet ports 81 of the gas suction units 80. In this state, gas is blown by the gas blowers 70 when the tablets T being conveyed by the conveyor belt 21a pass under the gas blowers 70. At this time, when deposits adhere to the tablets T, the deposits are blown away from the tablets T and sucked by the gas suction units 80 together with the air. In this manner, the deposits adhering to the tablets T are removed. Thus, it is possible to prevent printing on the tablets T to which deposits adhere, and a reduction in print quality can be suppressed.

In addition, the gas is blown onto the conveyor belt 21a by the gas blowers 70, a part of the gas is guided by the guide plate 90 to flow along the lower surface of the cover 60 in the conveying direction A1. As a result, the gas is blown against deposits adhering to the lower surface of the cover 60, and the deposits are blown away from the lower surface of the cover 60. The deposits are sucked by the gas suction units 80 together with the air. In this manner, the deposits adhered to the lower surface of the cover 60, that is, the transparent members 61 and 62, are removed. Thus, erroneous detection and recognition can be suppressed, and a reduction in print quality can be suppressed. Further, since the powder of the tablets T flying around the cover 60 can also be sucked and removed, the powder of the tablets T can be suppressed from adhering to the tablet T, the lower surface of the cover 60, the conveyor belt 21a, and the like. The longitudinal length of the guide plate 90, the length along the conveying direction A1, and the inclination angle are each set to a value that can blow off deposits adhering to the transparent members 61 and 62 so as not to contact the tablets T conveyed thereunder. The guide plate 90 is not limited to a flat plate and it may be a plate having a curved shape as long as deposits adhering to the transparent members 61 and 62 can be blown off.

As described above, a part of the gas flows along the lower surface of the cover 60 by the guide plate 90. The gas flowing along the lower surface of the cover 60 in the conveying direction A1 hits the control plate 27, and the part of the gas is sucked from the inlet port 81 of the gas suction unit 80. At this time, the deposits blown off from the lower surface of the cover 60 are also sucked through the inlet port 81 together with the gas. This prevents the airflow flowing along the lower surface of the cover 60 and the deposits blown off from the lower surface of the cover 60 from adversely affecting the printing of each of the print heads 24a. Thus, a reduction in print quality can be suppressed.

Incidentally, the conveyor belt 21a described above may sometimes vibrate when the tablet T is conveyed. At this time, deposits (for example, powder and dust) adhering to the conveyor belt 21a tend to fly up due to the swinging of the conveyor belt 21a. However, the flying is suppressed by the gas blown from the gas blowers 70. Even if the deposits fly up, the deposits are sucked by the gas suction units 80. Thereby, the deposits adhering to the conveyor belt 21a are prevented from adhering to the tablets T on the conveyor belt 21a. Thus, a reduction in print quality can be suppressed.

Further, in order to suppress the flying of powder caused by the above-mentioned airflow, the suction force of the suction hole 21g, that is, the suction force for sucking the tablets T, can be reduced in the whole or a part of the conveyor belt 21a (for example, in a predetermined area including an area below the print heads 24a) However, when the suction force for sucking the tablets T is weakened, the conveyor belt 21a may vibrate in the portion where the suction force is lowered. At this time, even if the deposit adhering to the conveyor belt 21a tend to fly up due to the swinging of the conveyor belt 21a, the flying is suppressed by the gas blown from the gas blowers 70. Even if the deposits fly up, the deposits are sucked by the gas suction units 80. Thereby, the deposits adhering to the conveyor belt 21a are prevented from adhering to the tablets T on the conveyor belt 21a. Thus, a reduction in print quality can be suppressed.

### (Modification of the Cover)

In the above example, the through holes 60e of the cover 60 are described as being formed so as to line up in the conveying direction A1; however, it is not so limited. The through holes 60e may be arranged in two or more rows, or they need not necessarily be formed in rows and may be randomly formed. Further, the through holes 60e may be formed in a slit shape.

In the above example, the detecting device 22, the first imaging device 23, the print head device 24, and the second imaging device 25 are described as being housed in the cover 60; however, it is not so limited. Because of the cover 60, powder does not adhere to the detecting device 22, the first imaging device 23, the print head device 24, and the second imaging device 25, and only the cover 60 can be detached and cleaned. Therefore, it is efficient when the type of tablets T is changed. However, if the deposit removing mechanism functions sufficiently, the cover 60 may be eliminated. At this time, the guide plate 90 is attached to the gas blowers 70. By eliminating the cover 60 as described above, it is possible to freely change the height position of each of the detecting device 22, the first imaging device 23, the print head device 24, and the second imaging device 25.

### (First Modification and Second Modification of the Gas Suction Unit)

In the above example, the inlet port 81 of the gas suction unit 80 is described as being formed in a rectangular shape extending in the conveying direction A1; however, it is not so limited. For example, the inlet port 81 may be formed in a triangular shape (first modification) that gradually narrows along the conveying direction A1. Alternatively, a plurality of rectangular inlet ports 81 having different elongated lengths may be arranged in the height direction with individual left ends aligned (second modification). In these cases, the suction force in the gas suction unit 80 gradually weakens along the conveying direction A1, that is, gradually decreases toward the print head device 24 side (right side in FIG. 7). Therefore, an airflow generated by the suction of the gas suction unit 80 can be prevented from adversely affecting the printing of the print head device 24. Thus, a reduction in print quality can be more reliably suppressed. Incidentally, the gas from the gas blowers is not supplied directly but is supplied via the guide plate 90 around the inlet ports 81 on the downstream side of the gas suction units 80 in the conveying direction A1. Therefore, there is no problem even if the amount of air sucked through the inlet port 81 decreases. It is also possible to arrange the circular or elliptical inlet ports 81 having different sizes in one row or a plurality of rows along the conveying direction A1.

### (Third Modification of the Gas Suction Unit)

In the above example, the suction force of the gas suction unit 80 is described adjustable by changing the length of the inlet port 81 of the gas suction unit 80 in the height direction; however, it is not so limited. For example, a suction force adjusting member (not illustrated) may be provided in the internal flow path 83 of the gas suction unit 80. The suction force adjusting member has a rectangular (slit-like) through hole extending in the conveying direction A1, and is provided in the inside of the internal flow path 83 so as to close it to adjust the suction force by changing the flow amount of the gas passing through the internal flow path 83. The suction force of the gas suction unit 80 can be easily adjusted by preparing several types of suction force adjusting members having different slit widths of the through holes (widths in a direction perpendicular to the conveying direction A1 in the horizontal plane in the through holes) and selecting one of them for use depending on the required suction force.

Although the through hole of the suction force adjusting member is formed in a rectangular shape extending in the conveying direction A1, it is not so limited. The through hole may be formed in various shapes such as a circular shape, an elliptical shape, a triangular shape, or the like. Besides, the number of the through holes is also not limited, and there may be a plurality of through holes. For example, a plurality of through holes having a circular shape, an elliptical shape, and the like may be formed to be aligned in the conveying direction A1, or may be formed to be aligned in a plurality of rows (for example, two rows or three rows). The through holes may also be formed irregularly (randomly).

The suction force adjusting member forming the through hole may be detachable so that it can be replaced when the type of the tablet T to be printed is changed. In this manner, even if the object to be printed is changed, the suction force can be easily adjusted. The suction force adjusting member may be attached anywhere within the gas suction unit 80, and may be attached to the inlet port 81 or may be attached to the outlet port 82.

In the above example, the gas suction units 80 are described as being provided only on the upstream side of the print head 24a in the conveying direction A1; however, it is not so limited. The gas suction units 80 may be provided in other places. The gas suction units 80 may be provided on the entire circumference of the conveyor belt 21a or a part thereof. Providing a plurality of the gas suction units 80 increases the opportunity to suck powder adhering to the conveyor belt 21a. Thus, it is possible to suppress a reduction in print quality due to the adhesion of powder to the print head 24a or the position shift of the tablet T during conveyance. Particularly, in the case where the gas suction unit 80 is provided in the portion where the centrifugal force is applied (the pulley body 21b portion, the driven pulleys 21c portion), powder adhering to the conveyor belt 21a is liable to float due to the centrifugal force. Accordingly, the powder can be sucked efficiently by the gas suction unit 80. Further, since the suction hole 21g of the conveyor belt 21a in the driven pulley 21c portion is not connected to the suction chamber 21f, the powder is not sucked through the suction hole 21g. Therefore, it is particularly effective to provide the gas suction unit 80 in this portion.

### Fourth Embodiment

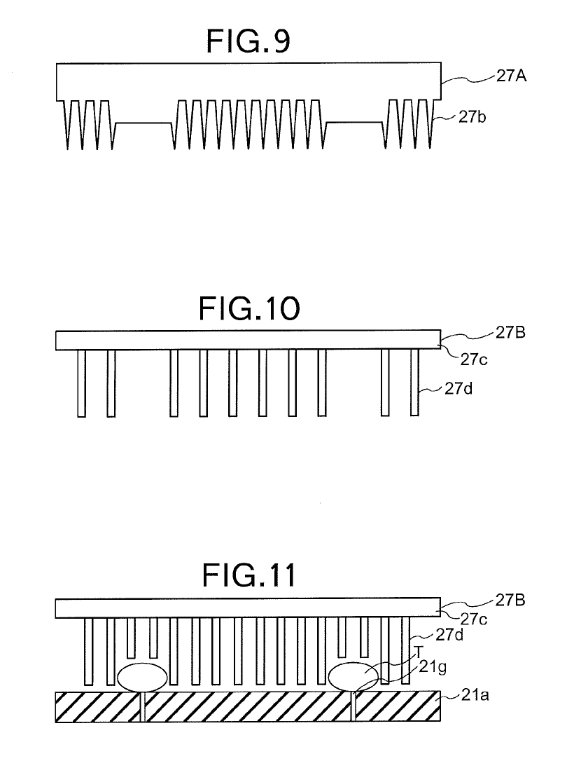

Next, a fourth embodiment will be described with reference to FIG. 9. In the fourth embodiment, differences (the configuration of the control plate) from the first embodiment will be described, and other explanation will be omitted.

As illustrated in FIG. 9, an end portion of the conveyor belt 21a side in a control plate 27A of the fourth embodiment is formed like saw so that a plurality of comb teeth 27b are aligned in the longitudinal direction (a direction perpendicular to the conveying direction A1 in the horizontal plane). Each of the comb teeth 27b is formed to gradually become narrower toward the lower side (that is, the upper surface of the conveyor belt 21a). With the control plate 27A, as in the above embodiments, it is possible to control the airflow generated between the conveyor belt 21a and each of the print heads 24a. Thus, a reduction in print quality due to the powder of the tablets T can be suppressed.

In addition to making the entire comb teeth 27b gradually narrower as described above, only the tip of the comb teeth 27b may be narrowed. In addition to making the comb teeth 27b gradually narrowed downward, the comb teeth 27b may be made to become gradually thick downward. Alternatively, the central portion of the comb teeth 27b may be thickened.

### Fifth Embodiment

Next, a fifth embodiment will be described with reference to FIGS. 10 and 11. In the fifth embodiment, differences (the configuration of the control plate) from the first embodiment will be described, and other explanation will be omitted.

As illustrated in FIG. 10, a control plate 27B of the fifth embodiment includes a support unit 27c and a plurality of comb teeth 27d. The support unit 27c is formed in a rectangular plate shape. The comb teeth 27d are provided at the lower end of the support unit 27c so as to be aligned in the longitudinal direction of the support unit 27c (a direction perpendicular to the conveying direction A1 in the horizontal plane). With the control plate 27B, as in the above embodiments, it is possible to control the airflow generated between the conveyor belt 21a and each of the print heads 24a. Thus, a reduction in print quality due to the powder of the tablets T can be suppressed.

Besides, the airflow flowing above the conveyor belt 21a along the conveying direction A1 hits the control plate 27B and passes through the opening portion where the airflow passes (space between the comb teeth 27d) in the control plate 27B. With the control plate 27B, as in the above embodiments, the airflow flowing above the conveyor belt 21a can be rectified into a laminar flow along the conveying direction A1. Further, it is possible to rectify the airflow on the conveyor belt 21a below and around the print head 24a into a laminar flow, thereby suppressing the occurrence of turbulence. With this, the shaking of the tablet T sucked and held by the conveyor belt 21a can be suppressed. Thus, it is possible to suppress a reduction in print quality due to the inability to maintain the posture of the print surface of the tablet T when the tablet T passes under the print head 24a.

Incidentally, the support unit 27c need not necessarily be in a rectangular plate shape, and it may be formed in another plate shape or a rod shape. The comb teeth 27d may be gradually narrowed downward, or it may be made gradually thicker downward. Alternatively, only the tip of the comb teeth 27d may be narrowed, or the central portion of the comb teeth 27d may be thickened. Further, as illustrated in FIG. 11, the comb teeth 27d may be provided at above a position where the tablet T passes so as not to contact the tablet T (at a height where the comb teeth 27d do not contact the tablets T). In the example of FIG. 11, the two comb teeth 27a that sandwich the tablet T conveyed by the conveyor belt 21a correspond to the “two adjacent comb teeth 27a”, and the horizontal distance between them is larger than the diameter of the tablet T to be printed (an example of the maximum size of the tablet T in the horizontal direction) according to the diameter of the tablet T.

### Sixth Embodiment

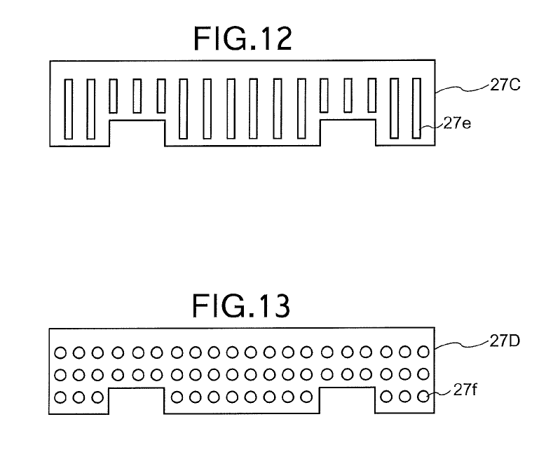

Next, a sixth embodiment will be described with reference to FIG. 12. In the sixth embodiment, differences (the configuration of the control plate) from the first embodiment will be described, and the other explanation will be omitted.

As illustrated in FIG. 12, in a control plate 27C of the sixth embodiment, a plurality of rectangular through holes 27e are formed in a row in the longitudinal direction (a direction perpendicular to the conveying direction A1 in the horizontal plane). With the control plate 27C, as in the above embodiments, it is possible to control the airflow generated between the conveyor belt 21a and each of the print heads 24a. Thus, a reduction in print quality due to the powder of the tablets T can be suppressed.

Besides, the airflow flowing above the conveyor belt 21a along the conveying direction A1 hits the control plate 27C and passes through the opening portion where the airflow passes (the through holes 27e) in the control plate 27C. With the control plate 27C, as in the above embodiments, the airflow flowing above the conveyor belt 21a can be rectified into a laminar flow along the conveying direction A1. With this, the shaking of the tablet T sucked and held by the conveyor belt 21a can be suppressed. Thus, it is possible to suppress a reduction in print quality due to the inability to maintain the posture of the print surface of the tablet T when the tablet T passes under the print head 24a.

Incidentally, the through holes 27e need not necessarily be in a rectangular shape, and they may have, for example, an elliptical shape or a triangular shape. Further, the through holes 27e need not necessarily be arranged at regular intervals, and may be arranged at irregular intervals. For example, there may be no through hole 27e above the position where tablet T passes. Alternatively, the opening area of the through hole 27e above the position where tablet T passes may be made smaller or larger than that of the through holes 27e provided in other places.

### Seventh Embodiment

Next, a seventh embodiment will be described with reference to FIG. 13. In the seventh embodiment, differences (the configuration of the control plate) from the first embodiment will be described, and other explanation will be omitted.

As illustrated in FIG. 13, in a control plate 27D of the seventh embodiment, a plurality of circular through holes 27f are formed to be aligned at a predetermined interval in the longitudinal direction of a rectangle (a direction perpendicular to the conveying direction A1 in the horizontal plane) and in the short side direction. As the control plate 27D, for example, a punching board or a mesh plate can be used. With the control plate 27D, as in the above embodiments, it is possible to control the airflow generated between the conveyor belt 21a and each of the print heads 24a. Thus, a reduction in print quality due to the powder of the tablets T can be suppressed.

Besides, the airflow flowing above the conveyor belt 21a along the conveying direction A1 hits the control plate 27D and passes through the opening portion where the airflow passes (the through holes 27f) in the control plate 27D. With the control plate 27D, as in the above embodiments, the airflow flowing above the conveyor belt 21a can be rectified into a laminar flow along the conveying direction A1. With this, the shaking of the tablet T sucked and held by the conveyor belt 21a can be suppressed. Thus, it is possible to suppress a reduction in print quality due to the inability to maintain the posture of the print surface of the tablet T when the tablet T passes under the print head 24a.

Incidentally, the through holes 27f need not necessarily be in a circular shape, and they may have, for example, a quadrilateral shape, an elliptical shape, or a triangular shape. In addition, the through holes 27f need not necessarily be arranged at regular intervals, and may be arranged at irregular intervals.

It is also possible to combine the embodiments illustrated in FIGS. 4, 9, 10, 11, 12 and 13. In each embodiment, the size and shape of the comb teeth 27a, 27b or 27d, or the size and shape of the through holes 27e or 27f are appropriately selected according to the size and shape of the tablet T. The airflow generated varies depending on the type of the tablet T. Therefore, the size and shape of the comb teeth 27a, 27b or 27d, or the size and shape of the through holes 27e or 27f are appropriately selected to control the direction of the airflow around the conveyor belt 21a and the print heads 24a, the distribution of the flow rate, and the like according to the size and shape of the comb teeth 27a, 27b or 27d, or the size and shape of the through holes 27e or 27f.

The “blocking portion in which the airflow is blocked” in the control plates 27, 27A and 27B corresponds to the plurality of comb teeth 27a, 27b and 27d. The “opening portion where the airflow passes” is a space between the teeth of the plurality of the comb teeth 27a, 27b and 27d. In addition, the “blocking portion in which the airflow is blocked” in the control plates 27C and 27D corresponds to a portion other than the plurality of through holes 27e and 27f. Besides, the “opening portion where the airflow passes” corresponds to the through holes 27e and 27f.

The control plate 27, 27A or 27B according to any one of the first to fifth embodiments is formed in a comb shape. Therefore, when the interior of the apparatus is cleaned to change the type of the tablet T to be printed, the control plate 27, 27A or 27B can be easily cleaned and kept clean as compared to the control plate 27C or 27D according to the sixth or seventh embodiment.

As described above, the control plate 27, 27A or 27B is formed in a comb shape. Therefore, by letting the airflow flowing above the conveyor belt 21a pass between the teeth of the plurality of comb teeth 27a, 27b or 27d, the airflow is rectified to an airflow along each of the comb teeth, and can be more easily rectified into a laminar flow flowing along the conveying direction A1. Thereby, as described above, it is possible to perform printing as well as suppressing the occurrence of turbulence that may shake the tablet T sucked and held on the surface of the conveyor belt 21a.

In addition, the control plate 27, 27A or 27B is formed in a comb teeth shape and arranged so as to open toward the upper surface of the conveyor belt 21a. That is, although the lower end portion of the control plate 27, 27A or 27B is open, if the lower end portion of the control plate 27, 27A or 27B is not open, the gap between the conveyor belt 21a and the lower end portion of the control plate 27, 27A or 27B becomes narrower. Accordingly, it is presumable that the flow rate of the airflow passing through this gap increases, resulting in the further generation of turbulence. However, if the control plate 27, 27A or 27B is formed in a comb teeth shape, it is possible to reduce the portion which blocks the airflow around the conveyor belt 21a. Accordingly, the flow rate increases near the conveyor belt 21a, and further turbulence does not occur on the surface of the conveyor belt 21a below the print head 24a. Thus, printing can be performed while the shaking of the tablet T sucked and held can be suppressed.

### Other Embodiments

In the above embodiments, an example is described in which the tablets T are conveyed in two rows; however, it is not so limited. The number of rows is not particularly limited, and there may be one row, three rows, or four or more rows.

In the above embodiments, there is provided only one conveyor belt 21a; however, it is not so limited. The number of conveyor belt is not particularly limited, and there may be two or more conveyor belts. For example, a plurality of conveyor belts 21a may be arranged in parallel.

In the above embodiments, the suction holes 21g of the conveyor belt 21a is described as being circular; however, it is not so limited. The shape of the suction holes 21g of the conveyor belt 21a is not particularly limited, and the suction holes may be in a rectangular shape, an elliptical shape, or a slit-like shape.

In the above embodiments, the print head 24a is described as being provided for each conveying path of the tablet T; however, it is not so limited. For example, printing on two or more rows of tablets T may be performed by one print head 24a.

In the above embodiments, a print head in which the nozzles 24b are arranged in a row is exemplified as the ink jet print head 24a; however, it is not so limited. For example, a print head in which the nozzles 24b are arranged in a plurality of rows may be used. Further, a plurality of print heads 24a may be arranged side by side along the conveying direction A1 of the tablets T.

In the above embodiments, an example is described in which the first printing device 20 and the second printing device 30 are placed one on top of the other to perform printing on both sides or one side of the tablet T; however, it is not so limited. For example, only the first printing device may be provided to perform printing only on one side of the tablet T.

In the above embodiments, the gas blower 42a is described as being provided to the non-defective product collecting unit 42; however, it is not so limited. For example, the gas blower 42a may be provided to the end portion of the conveying device 31 side in the conveying device 21 or a place where the tablets T is transferred from the transfer feeder 13 to the conveying device 21. In other words, the gas blower 42a may be used at a place where the tablet T is desired to be taken off from the conveyor belt 21a.

In the above embodiments, the gas blower 42a is described as always blowing out gas during the process; however, it is not so limited. The gas blower 42a may blow out gas intermittently.

In the above embodiments, the control plates 27 and 37 are described as being flat plates; however, it is not so limited. For example, the control plates 27 and 37 may be curved plates.

In the above embodiments, the control plate 27 is described as being arranged to be perpendicular to the lower surface (nozzle surface M1) of each of the print heads 24a; however, it is not so limited. For example, the control plate 27 may be inclined with respect to the conveying direction A1.

In the second embodiment, the control plate 27 is described as being arranged between the imaging unit 23a and the print head 24a on the lower surface of the cover 60; however, it is not so limited. The control plate 27 may be arranged at the tip of the cover 60 on the upstream side in the conveying direction A1 (upstream side in the tablet conveying direction).

In the third embodiment, the guide plate 90 is described as being in a rectangular shape; however, the guide plate 90 may have a shape provided with comb teeth or through holes, that is, a shape having an opening portion and a blocking portion. In this case, it is possible to rectify the gas ejected from the gas blowers 70, and deposits can be prevented from adhering again by the rectified airflow. In addition, it is also possible to suppress the generation of new turbulence caused by the ejection of the gas from the gas blowers 70. Note that if the guide plate 90 in FIG. 7 is in a shape having an opening portion and a blocking portion, the control plate 27 can be eliminated.

The above-described tablets may include tablets for pharmaceutical use, edible use, cleaning, industrial use, and aromatic use. Examples of the tablet include a plain tablet (uncoated tablet), a sugar-coated tablet, a film-coated tablet, an enteric coated tablet, a gelatin coated tablet, a multilayered tablet, a dry-coated tablet, and the like. Examples of the tablet further include various capsule tablets such as hard capsules and soft capsules. The tablets may be in a variety of shapes such as, for example, a disk shape, a lens shape, a triangle shape, an oval shape, and the like. In the case where tablets to be printed are for pharmaceutical use and edible use, edible ink is suitably used. As the edible ink, any of synthetic dye ink, natural color ink, dye ink, and pigment ink may be used.

While certain embodiments have been described, these embodiments have been presented by way of example only, and are not intended to limit the scope of the inventions. Indeed, the novel embodiments described herein may be embodied in a variety of other forms; further, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A tablet printing apparatus, comprising:
a conveyor belt including a suction hole connected to a suction chamber, and configured to convey a tablet while sucking the tablet to the suction hole;
an ink jet print head having a nozzle surface where a nozzle is formed, located above the conveyor belt such that the nozzle surface faces the conveyor belt, and configured to perform printing on the tablet conveyed by the conveyor belt; and
a control plate located on an upstream side of the print head in a conveying direction of the tablet between the conveyor belt and a height position of the nozzle surface of the print head, and configured to control an airflow generated between the conveyor belt and the print head.

2. The tablet printing apparatus according to claim 1, wherein
the control plate is arranged such that its longitudinal direction is perpendicular to the conveying direction of the tablet in a horizontal plane, and
the control plate includes
a blocking portion configured to block an airflow generated between the conveyor belt and the print head and flowing along the conveying direction of the tablet, and
an opening portion through which the airflow passes.

3. The tablet printing apparatus according to claim 1, wherein a plurality of comb teeth is formed so as to be aligned along a direction perpendicular to the conveying direction of the tablet in a horizontal plane, in an end portion of conveyor belt side in the control plate.

4. The tablet printing apparatus according to claim 1, wherein a plurality of through holes are formed in the control plate so as to penetrate the control plate in the conveying direction of the tablet.

5. The tablet printing apparatus according to claim 1, wherein a part of lower end of the control plate is located at a position higher than upper surface of the conveyor belt and lower than apex of the tablet on the conveyor belt.

6. The tablet printing apparatus according to claim 3, wherein horizontal distance between two adjacent teeth of the comb teeth, which sandwich the tablet T conveyed by the conveyor belt, is larger than maximum size of the tablet in the horizontal direction.

7. The tablet printing apparatus according to claim 3, wherein the comb teeth are located above the tablet passing as being conveyed by the conveyor belt, and are provided with the control plate so as not to contact the tablet.

8. The tablet printing apparatus according to claim 1, further comprising:
a housing configured to house the print head; and
a gas blower and a gas suction unit arranged on an upstream side of the print head in the conveying direction of the tablet, wherein
the gas blower is configured to blow a gas to upper surface of the conveyor belt, and
the gas suction unit is configured to suck the gas blown by the gas blower.
